(19) United States
(12) Patent Application Publication
(10) Pub. No.: US 2007/0165662 A1
(43) Pub. Date: Jul. 19, 2007

(54) Communication line termination device

(76) Inventors: Hector Glenn Morgan, Conception Bay South (CA); Frederick Wayne Parsons, St. John's (CA)

Correspondence Address: SMART & BIGGAR;P.O. BOX 2999, STATION D, 900-55 METCALFE STREET, OTTAWA, ON, K1P5Y6, CA

(21) Appl. No.: 11/334,424

(22) Filed: Jan. 19, 2006

(51) Int. Cl. H04L 12/28

(52) U.S. Cl. 370/419

(57) ABSTRACT

Communication line termination devices and associated methods of manufacturing and deploying such devices are disclosed. A communication line termination device includes a device housing, an electrical terminal carried by the housing for connection to a communication line, and a termination circuit connected to the terminal and carried by the housing. The termination circuit has an impedance matching a characteristic impedance of the communication line, and thus reduces communication signal reflection on the communication line.

### FIELD OF THE INVENTION

This invention relates generally to communications and, in particular, to devices for terminating communication lines.

### BACKGROUND

Currently, in the deployment of XDSL (Digital Subscriber Line) technologies such as ADSL (Asymmetrical DSL), HDSL (High data-rate DSL), SHDSL (Single-line HDSL), and ADSL2 and 2+, total accessible bandwidth is limited by a number of factors. These factors include, but are not limited to, the quality and gauge of the physical cable pair, the environment, wiring inside customers' premises, and total length of the cable including bridged taps and end sections.

Bridged taps and end sections are integral to the majority of copper deployment in North America. Most copper infrastructure deployed in the past 50 years uses the standard Bellcore design specifications. This type of design, although cost effective and an easy build-on for voice grade services, leaves significant issues for high-frequency technologies such as ADSL. Bridged taps and end sections may affect each and every customer who subscribes to XDSL services in one way or another. For some customers, maximum achievable bandwidth is reduced, whereas for others the stability of a connection is limited. These issues often require “Truck Rolls” or other service provider personnel intervention. In some cases, potential customers might be prevented from having service at all.

Consider how a bridged tap or end section affects xDSL services today. From a DSLAM (DSL Access Multiplexer), the signal leaves on a cable pair and travels on down a communication line to a customer modem. If the communication line continues past the customer, as in the case of a bridged tap for instance, some of that signal continues past the customer to the line end. When the signal reaches the end of the line, at least a portion of the signal is reflected back toward the modem. A signal may be reflected at multiple locations, such as where a main line has several taps. The reflected signal(s) may be interpreted by the modem as noise, and to deal with the noise the modem may stop sending signals on the specific frequencies affected, thereby reducing overall bandwidth. Reflected signals also affect communication signal reception, reducing the SNR (Signal-to-Noise Ratio) on a communication line.

There are two common methods used to deal with the impacts of bridged taps and end sections. First, there is a so-called “slash and burn” approach, where a communication line is cut to clear signal reflection. A service provider following this approach might wait for an affected customer to report a problem, and then dispatch personnel to cut the bridged tap or end section from which signals are reflected. This tends to be costly and time consuming, especially when multiple truck rolls to the same location are required to trim affected pairs for different customers, one at a time. Costly rebuilds can also result when areas are reengineered. Another problem with this approach is that records of line cuts are rarely maintained.

Another signal reflection reduction method involves full line or “plant” dedication. According to this approach, a system is designed with each pair dedicated to an address and built with all bridged taps and end sections eliminated. This may be feasible for new system design, but does not address signal reflection problems for the millions of lines already in service. Plant dedication for existing customers would require significant capital investment and huge amounts of dedicated design and labor. In addition, service outages are often experienced during cutovers to newly installed lines.

Thus, there remains a need for improved techniques for dealing with communication signal reflection.

### SUMMARY OF THE INVENTION

According to one aspect of the invention, there is provided a communication line termination device. The device includes a device housing, an electrical terminal carried by the housing for connection to a communication line, and a termination circuit connected to the terminal and carried by the housing. The termination circuit has an impedance matching a characteristic impedance of the communication line.

The housing may be moulded over the termination circuit or include housing sections assembled over the termination circuit, for example.

In some embodiments, the device is adapted for use with a further device such as a modular splice connector. The further device has a terminal for connection to the communication line, and the device terminal is disposed on the housing for contacting the further device terminal to thereby connect the device terminal to the communication line through the further device terminal. The device terminal and the further device terminal may be carried by complementary structures of the housing and the further device. The complementary structures may also releasably secure the device and the further device in engagement.

The communication line may include multiple conductors, in which case the terminal may include multiple terminal elements for respective connection to the multiple conductors.

The termination circuit may include one or more components selected from the group consisting of: passive components and active components. A protection component may also or instead be provided in the termination circuit.

In some embodiments, the device also includes one or more further terminals carried by the housing for connection to respective further communication lines and one or more further termination circuits respectively connected to the one or more further terminals and disposed in the housing.

A method of making a communication line termination device, according to another aspect of the invention, involves providing an electrical terminal for connection to a communication line and a termination circuit for connection to the terminal, the termination circuit having an impedance matching a characteristic impedance of the communication line, and installing the terminal and the termination circuit on a housing.

The operation of installing may include one or more of: moulding the housing and assembling the housing.

The housing may include a structure for carrying the terminal. The structure may have a complementary shape to a terminal carrying structure of a further device, the terminal carrying structure of the further device carrying a terminal for connection to the communication line. In this case, the operation of installing involves installing the device terminal on the device housing structure for contacting the further device terminal to thereby connect the device terminal to the communication line through the further device terminal.

In some embodiments, providing further includes providing a connector circuit for connection to the terminal, and installing further includes installing the connector circuit on the housing.

If the communication line includes multiple conductors, providing may involve providing multiple terminal elements of the terminal for respective connection to the multiple conductors.

In some embodiments, providing the termination circuit involves providing one or more components selected from the group consisting of: resistors, capacitors, and inductors. Providing may also or instead involve providing a protection component.

Multiple terminals may be provided for connection to respective communication lines, in which case multiple termination circuits may be provided for connection to respective terminals of the plurality of terminals.

A method according to another aspect of the invention includes operations of connecting a communication line to a modular splice connector, and securing a termination device to the modular splice connector. The termination device includes a terminal for connection to the communication line through the modular splice connector, a termination circuit connected to the terminal and having an impedance matching a characteristic impedance of the communication line, and a housing carrying the terminal and the termination circuit.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings, in which:

FIG. 1 is a block diagram of an example communication system.

FIG. 2 is a block diagram of a communication line termination device.

FIG. 3 is a block diagram of a communication line termination device, and shows details of an example termination circuit.

FIG. 4 is a block diagram of a communication line termination device and other devices for connection to a communication line.

FIG. 5 is a flow diagram of a method according to an embodiment of the invention.

FIGS. 6A and 6B are representative example TDR (Time Domain Reflectometry) plots illustrating effects of communication line termination techniques disclosed herein.

### DETAILED DESCRIPTION OF PREFERRED EMBODIMENTS

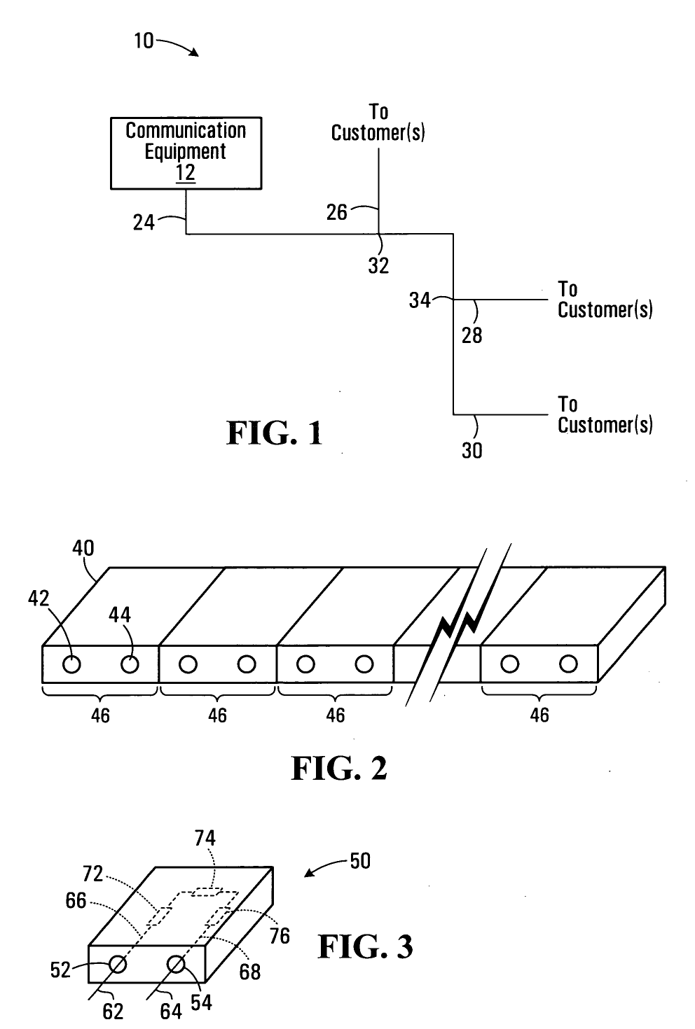

FIG. 1 is a block diagram of an example communication system 10, in which embodiments of the invention may be implemented. The communication system 10 includes communication equipment 12 connected to multiple customer access points using the same physical cable complements, specifically a communication line 24 and respective line sections 26, 28, 30 connected to tap points 32, 34.

A communication system may include more than a single installation of communication equipment 12. A DSL service provider's system may include multiple DSLAMs and/or other types of equipment located at or connected to a central office, for instance. Thus, a communication system may include further components that have not been explicitly shown in FIG. 1 so as to avoid overly complicating the drawing. In addition, the techniques disclosed herein may be applied to communication schemes other than DSL. It should therefore be appreciated that the system 10 of FIG. 1, as well as the contents of the other drawings, are intended solely for illustrative purposes, and that the present invention is in no way limited to the particular example embodiments explicitly shown in the drawings and described herein.

Considering an illustrative example of a DSL system, those skilled in the art will be familiar with DSL communication equipment such as a DSLAM, which may be provided as the communication equipment 12, the operation of such equipment, and the manner in which the equipment may be connected. In a DSL system, the communication line 24 and sections 26, 28, 30 may be a 100-pair cable, for example, with each pair being used for a connection to a customer. Bridged tap connectors for tapping the main line 24 at 32, 34 without ending the line are also commercially available.

Embodiments of the invention address signal reflection phenomena that affect DSL communications and other types of communication signals. These phenomena are not specific to DSL, and accordingly the techniques disclosed herein may be equally applicable to non-DSL communications.

In a typical implementation, the main line 24 and the line sections 26, 28, 30 are all connected together, as shown. For example, a 100-pair cable might be run from the communication equipment 12 to the tap point 32, to the tap point 34, and also to the customers at the end of the line section 30. Thus, pairs 1-25 may serve customers on the line section 26, but continue past those customers to the line sections 28, 30. Signals sent to customers on the line section 26 can be affected by reflections from the ends of the line sections 28, 30. In the above example, although only pairs 26-50 and 51-75 might be used on the line sections 28, 30 to actually service customers, all pairs could be run from the tap point 34 toward customer premises, illustratively to pole-top equipment for instance.

This type of communication line extension provides the maximum flexibility for system redesign and service expansion, in that all pairs remain available for use at all line sections. Suppose that customer demand at the line section 30 exceeds expected levels. Instead of running a new main line out to the line section 30, previously unused pairs in the line section 26 or 28 can be set up for customer connections.

However, signals are reflected from line extension segments and can cause communication problems. According to one of the conventional techniques described above, pairs 1-25 of the main line 24 would be cut at the downstream or access side of the tap point 32, so as to avoid signal reflection on those pairs at the other line sections. Pairs 26-51 could similarly be cut at the tap point 34. Cut pairs must be re-connected in the event that those pairs are to be used at other locations, where a service provider wishes to redistribute customer load for instance.

In a dedicated line approach, pairs 1-25, 26-50, and 51-75 would be dedicated from the location of the communication equipment 12 to the line sections 26, 28, 30 respectively.

Each of these conventional approaches has significant drawbacks, as described above.

According to an embodiment of the invention, a new termination device is used to deal with signal reflection problems associated with bridged taps and end sections. This device could be installed at the ends of any or all bridged taps and end sections to reduce signal reflection, thereby improving SNR. Termination devices could be installed at the ends of any or all cable pairs on the line sections 26, 28, 30, for example.

Reducing signal reflection increases SNR, which would improve communications and reduce trouble calls, increase the amount of bandwidth available to a customer, and extend communication service reach to previously unserviceable areas. Decreased operating expenses and/or increased revenues could thus be realized.

As described in further detail below, a termination device includes a termination circuit for terminating a communication line. The termination circuit might be an RC circuit, including a combination of a balanced capacitor and resistors for instance.

Impedance matching techniques have been used in electrical power systems, for example, to reduce power signal reflection at power line ends. Terminating a power line in its characteristic impedance, also known as surge impedance, eliminates or at least significantly reduces signal reflection. Characteristic impedance for power line conductors is typically specified by manufacturers.

Communication lines, however, present significant challenges for impedance matching-based signal reflection reduction. In general, communication lines are more densely packed than power lines. A single communication cable may include hundreds of pairs. In order to fully implement impedance matching for this cable, each pair, or in some cases each conductor of every pair, would need to be terminated in its characteristic impedance. For per-pair impedance matching in the case of a 100-pair cable, 100 termination circuits must be deployed, often in less space than would be available for terminating only a few power cables.

The physical space limitation can be further compounded where multiple components are used in a termination circuit. Characteristic impedance might have both real and imaginary components, such that an effective impedance matching circuit would incorporate both passive and active components.

Termination circuit component handling and connection may also be a problem where multiple circuits and/or components are to be connected to a communication line or multiple-line cable.

Deployment of a termination device in a cost effective manner can thereby go well beyond simply connecting circuit components to a communication line. In accordance with an aspect of the invention, a termination circuit and a terminal for connection to a communication line are carried by a device housing.

FIG. 2 is a block diagram of such a communication line termination device. The device 40 includes a housing which carries an electrical terminal for connection to a communication line and a termination circuit connected to the terminal. The termination circuit has an impedance that matches a characteristic impedance of the communication line, as described in further detail below.

The termination circuit and terminal are carried inside the device 40 and accordingly have not been explicitly shown in FIG. 2. Terminal carrying structures, cavities in FIG. 2, are shown at 42, 44. The terminals may be binding posts, insertion terminals, screw terminals, or some other terminal type for connection to a communication line. Many examples of such terminals will be apparent to those skilled in the art.

A communication line would be connected to a terminal in the device 40 by inserting the line into one of the cavities 42, 44. In the device 40, a terminal carrying structure pair 46 is provided for carrying terminal elements for connection to respective conductors of a communication line. Although multiple pairs 46 are shown, it should be appreciated that single-pair termination devices are also contemplated. It is also possible that the communication line(s) to be terminated by a device according to an embodiment of the invention may include more or fewer than two conductors.

The housing of the device 40 may be made from an electrically insulative or dielectric material such as polycarbonate or PVC (polyvinyl chloride). Other suitable materials may be apparent to those skilled in the art.

Any of various manufacturing techniques may be used to form the housing. For example, the housing might be moulded over at least a portion of the termination circuit and/or the terminal(s). In another embodiment, the housing is provided in sections and assembled to enclose at least the termination circuit.

FIG. 3 shows a communication line termination device, including details of an example termination circuit. The device 50 would be used to terminate a single-pair communication line, although it should be apparent that a termination device may terminate one or more communication lines, each line having one or more conductors.

A terminal element 66, 68 for connection to conductors 62, 64 of a communication line pair would be provided in each terminal carrying structure 52, 54. The conductors 62, 64 would be tip and ring conductors in a typical twisted pair communication line. According to one embodiment of the invention, the terminal elements 66, 68 are compatible with terminal elements provided in commercially available communication line splice connectors, although it should be appreciated that other terminal element types and structures may also or instead be used. In order to avoid congestion, details of the terminal elements 66, 68 have not been shown in FIG. 3.

The terminal elements 66, 68 are connected to the termination circuit, which in the example shown includes components 72, 74, 76. In one embodiment, the components 72, 76 are resistors and the component 74 is a capacitor. A termination circuit with two 20Ω resistors and a 0.10 μF capacitor has been found to reduce signal reflection in one test setup, although other circuit component values may be used to match other values of characteristic impedance. Characteristic impedance varies between different conductor gauges, for example, and a termination circuit can be designed according to the characteristic impedance specified for a particular communication line.

Other circuit topologies than the simple series connection topology shown in FIG. 3 are also possible.

It should be noted that “matching” is not intended to imply that exact matching of characteristic impedance is required. Electrical circuit component values are never known with absolute accuracy, but rather within certain tolerances. Some level of signal reflection reduction may be achieved without exactly matching a communication line's characteristic impedance, although it is generally preferable to match characteristic impedance as accurately as possible.

A termination circuit may include other components than impedance components such as resistors, capacitors, and in some cases inductors. For example, a protection component may also be provided. A protection device could be connected between either or each of the terminal elements 66, 68 and the components 72, 76. A gas tube is one example of a protection device that would temporarily open to protect the components 72, 74, 76 from surges caused by lightning strikes, for example.

It may also be desirable to protect a terminated communication line from failures in a termination circuit. A PTC (Positive Temperature Coefficient) failsafe component could be connected to one or both of the terminals 66, 68 to prevent a failure in a component of the termination circuit from having any impact on communication services provided over the pair 62, 64. The electrical resistance of a PTC component increases sharply when temperature is raised. The higher the coefficient, the greater an increase in electrical resistance for a given temperature increase. This effect can be used to create re-settable fuses, often as part of a semiconductor. As the temperature rises and nears danger levels, the resistance increases, and less current flows, thereby protecting the equipment receiving the flow.

The termination devices shown in FIGS. 2 and 3 allow impedance matching termination circuits to be deployed in a convenient and time-effective manner. In some embodiments, multiple lines can be terminated by installing a single termination device.

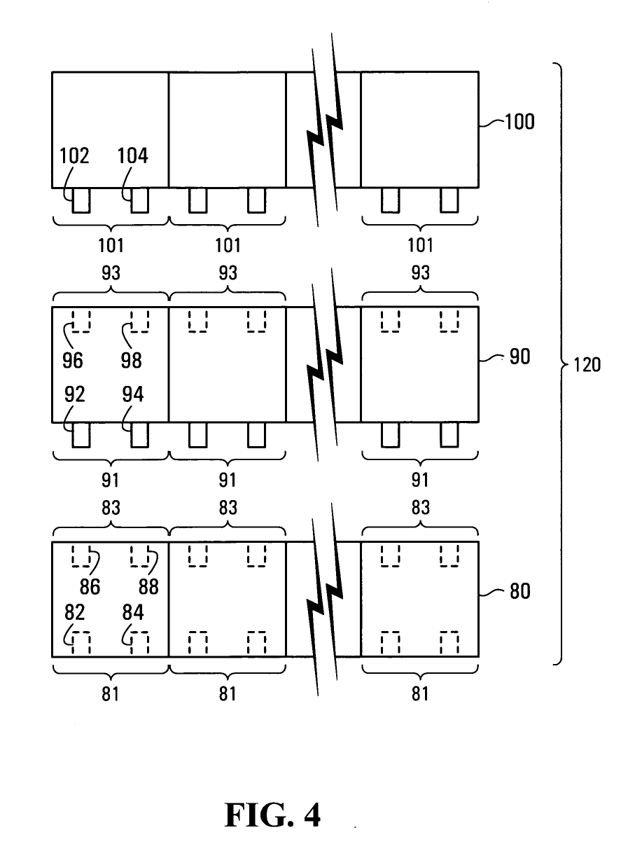

A termination device may be designed for use on its own, or in conjunction with other devices. FIG. 4 is a block diagram of a communication line termination device and other devices for connection to a communication line, and thus illustrates an example of the latter termination device design.

In FIG. 4, three devices 80, 90, 100 are secured together to form a multi-device connector 120. The device 80 might be a modular splice connector, for example, that includes pairs 81 of terminal carrying structures 82, 84 in or on which communication line terminal elements are carried. The terminal elements are for connection to conductors of respective communication lines. Such a connector might provide a connector circuit such as a bridged tap circuit, for example, for splitting communication lines. With reference to FIG. 1, a bridged tap connector may be provided at each of the tap points 32, 34, to allow the line sections 26, 28, 30 to be tapped off the main line 24. Segments of the main line 24 could be connected at terminal elements carried by the structures 82, 84 or 86, 88.

In the example shown in FIG. 4, a tapped line section may be connected to the main line using another connector 90. Terminal elements carried by the pairs 91 of the structures 92, 94 contact terminal elements carried by the pairs 83 of structures 86, 88 when the devices 80, 90 are assembled together. Terminal elements might be carried on mating surfaces of the structures 86, 88 for instance. Conductors of a tapped line section may be connected to the terminal elements at 92, 94 or terminal elements carried by the pairs 93 of structures 96, 98. Terminal elements of the device 90 are thereby connected to communication lines indirectly, through the device 80.

Various types of bridged tap and line section connectors 80, 90 are currently commercially available, and are commonly referred to as modular splice connectors or biscuits. Identical or substantially similar connectors may also be used to connect network-side and access-side communication lines. In this case, devices 80, 90 are provided at a network-side line end and an access-side line end. Customer drop lines connect to the access-side line end device and customer premises equipment, illustratively modems.

The device 100 includes terminals and termination circuits as described above for terminating multiple pairs of a communications cable. Terminal elements carried by the pairs 101 of structures 102, 104 contact terminal elements of the device 90 when the devices 100, 90 are assembled together. One or more communication lines connected to the device 80 may thus be conveniently terminated with a matching impedance.

Modular splicing using devices such as 80, 90 was introduced to reduce time-consuming pair by pair splicing methods. The device 100 may be adapted for use with a modular splice connector such as a 25-pair connector. The device 100 may, for example, be a modified version of a splice connector. Assembly of the device 100 with another device may be as simple as crimping the device 100 to the other device. In other embodiments, the terminal carrying structures on mating devices have complementary shapes, and releasably secure the devices together. In FIG. 4, the terminal carrying structures 86, 88 and 96, 98 are cavities, and their counterpart structures 92, 94 and 102, 104 are posts or protrusions having a complementary shape.

The structures 86, 88 and 92, 94 and the structures 96, 98 and 102, 104, in addition to carrying terminal elements, may also serve to releasably secure the devices 80, 90, 100 in engagement with each other. A friction fit, rib/detent combination, or other arrangements may be used for this purpose.

The devices 80, 90, 100 need not necessarily be of exactly the same size. Multiple single-pair connectors 100 could be installed on a 25-pair connector 90 for instance.

In areas where modular connectors have not been used, the device 100 may still be used to terminate communication lines. A termination device may thus be used on its own or in combination with other devices.

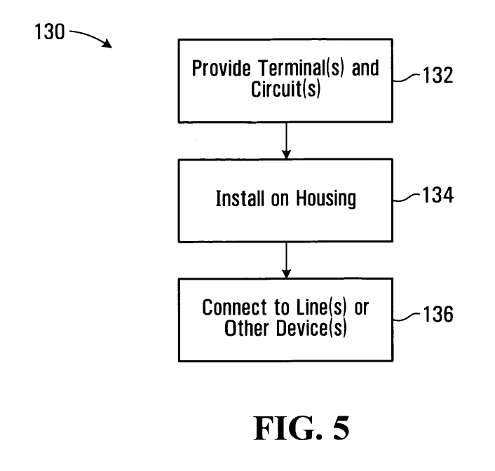

FIG. 5 is a flow diagram of a method according to an embodiment of the invention. The method 130 begins at 132, with providing an electrical terminal for connection to a communication line and a termination circuit for connection to the terminal. At 134, the terminal and the termination circuit are installed on a housing. The terminal and circuit may be installed on the housing such that they are partially or entirely enclosed by the housing, or carried on an exterior surface of the housing.

The operations at 132, 134 relate to manufacturing a termination device, which may subsequently deployed at 136 by connecting the device to one or more communication lines, directly or through another device, as described above.

The method 130 is intended solely for illustrative purposes. Other embodiments of the invention may involve further or fewer operations and/or performing operations in a different order than shown. For example, multiple terminals and circuits may be provided at 132 and installed in the housing at 134 where a device is to terminate multiple communication lines. The installation operation at 134 may involve installing other components such as one or more protection devices and/or an insulating grease in the case of a grease-filled device, in the housing. Further variations may also be apparent to those skilled in the art.

Recent experimental tests have shown that termination devices according to embodiments of the invention, when installed on bridged taps within a typical DSL serving footprint (4 km or less), improved quality of connections on 92% of tested loops and created a 12% average increase in overall line capacity as well as an average of 5 dB increase in SNR.

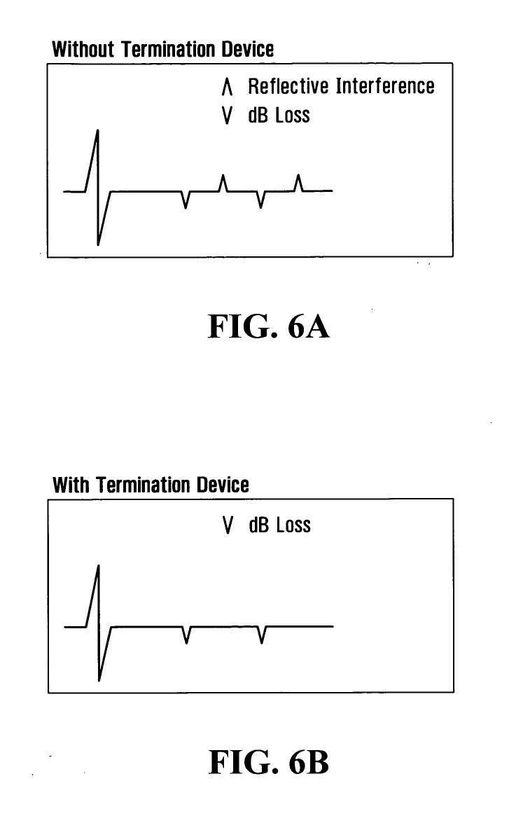

FIGS. 6A and 6B are representative example TDR plots illustrating the effects of using a communication line termination device according to an embodiment of the invention in another test scenario. A comparison of the plots shows that reflective interference is eliminated when a termination device is used. The specific levels of reflective interference and the amounts by which such interference is reduced may vary between different test conditions or different actual field conditions.

In further testing using a prototype device incorporating a termination circuit that included two 20Ω resistors and a 0.10 μF capacitor connected as shown in FIG. 3, the prototype device was installed and tested on 12 specific loops serving ADSL customers. On every loop, increased stability and bandwidth was achieved. More specifically, the average increase in available bandwidth in the test customer sample was 29%, and one customer had an increase of 130%. This increased bandwidth moved most of the tested loops from a marginal status of service to the ability for some customers to have enhanced service.

One test customer was serviced using a bridged tap connection. The line was configured to a standard 1600 kbps downstream speed and 640 kbps upstream speed, but was affected by signal dropping and extremely slow speeds. These problems tend to develop when the DSL average SNR drops below 6 dB, at which point a modem will begin to retrain, to attempt to reconnect at a lower speed.

Before a termination device was installed, maximum connection speeds were 740 kbps with 4 dB SNR (downstream) and 420 kbps with 6 dB SNR (upstream). This improved to 2384 kbps with 13 dB SNR (downstream) and 640 kbps with 7 dB SNR (upstream) when a termination device was installed. The termination device increased the speed beyond that normally required, and SNR, which may be considered a measure of stability of a connection, also significantly increased above minimum requirements.

In addition to anticipated decreases in customer trouble reports and truck rolls, the use of termination devices as disclosed herein may provide opportunities to sell greater bandwidth services to customers who are today viewed as marginal or unserviceable.

Communication service providers understand the importance of XDSL services in relation to the growing competitive landscape in the current market. Delivery of cost effective, stable technologies over twisted pair lines is necessary if pair-based services are to compete with services provided over other physical media. With the deployment of IP (Internet Protocol) based entertainment services such as IPTV, service providers may need to rely on their existing copper pair plant for quite some time to come.

The techniques disclosed herein may be used to help stabilize connections, increase bandwidth, and reduce costly truck rolls, which can in turn lead to increased revenues and/or reduced operating costs. Termination devices can be placed at physical cable ends and/or tap points, and adds minimal loss to the overall loop. When a signal reaches the device, the device does not allow a reflection to return. In operation, the termination device acts as a signal “capturer”. The device effectively makes the loop “look” longer without any additional degrading loss, thereby eliminating the reflection effects of bridged taps and end sections.

What has been described is merely illustrative of the application of principles of embodiments of the invention. Other arrangements and methods can be implemented by those skilled in the art without departing from the scope of the present invention.

For example, although described primarily in the context of DSL communications, the inventive techniques may be applied to other types of communications.

In addition, the techniques disclosed herein may be applied to any of various types of physical communication line. Whereas telephone companies typically utilize 19, 22, 24, and 26 gauge copper lines for instance, the present invention is in no way limited to these, or any, specific conductors having particular impedance, insulative, or other properties.

We claim:

1. A communication line termination device comprising:
a device housing;
an electrical terminal carried by the housing for connection to a communication line;
a termination circuit connected to the terminal and carried by the housing, the termination circuit having an impedance matching a characteristic impedance of the communication line.

2. The device of claim 1, wherein the housing comprises a housing moulded over the termination circuit.

3. The device of claim 1, wherein the housing comprises a plurality of housing sections assembled over the termination circuit.

4. The device of claim 1, wherein the device is adapted for use with a further device, the further device having a terminal for connection to the communication line, the device terminal being disposed on the housing for contacting the further device terminal to thereby connect the device terminal to the communication line through the further device terminal.

5. The device of claim 4, wherein the device terminal and the further device terminal are carried by complementary structures of the housing and the further device.

6. The device of claim 5, wherein the complementary structures releasably secure the device and the further device in engagement.

7. The device of claim 4, wherein the further device comprises a modular splice connector.

8. The device of claim 1, wherein the communication line comprises multiple conductors, and wherein the terminal comprises multiple terminal elements for respective connection to the multiple conductors.

9. The device of claim 1, wherein the termination circuit comprises one or more components selected from the group consisting of: passive components and active components.

10. The device of claim 1, wherein the termination circuit comprises a protection component.

11. The device of claim 1, further comprising:
one or more further terminals carried by the housing for connection to respective further communication lines; and
one or more further termination circuits respectively connected to the one or more further terminals and disposed in the housing.

12. A method of making a communication line termination device, comprising:
providing an electrical terminal for connection to a communication line and a termination circuit for connection to the terminal, the termination circuit having an impedance matching a characteristic impedance of the communication line; and
installing the terminal and the termination circuit on a housing.

13. The method of claim 12, wherein installing comprises one or more of: moulding the housing and assembling the housing.

14. The method of claim 12, wherein the housing comprises a structure for carrying the terminal, the structure having a complementary shape to a terminal carrying structure of a further device, the terminal carrying structure of the further device carrying a terminal for connection to the communication line, and wherein installing comprises installing the device terminal on the device housing structure for contacting the further device terminal to thereby connect the device terminal to the communication line through the further device terminal.

15. The method of claim 12, wherein providing further comprises providing a connector circuit for connection to the terminal, and wherein installing further comprises installing the connector circuit on the housing.

16. The method of claim 12, wherein the communication line comprises multiple conductors, and wherein providing comprises providing multiple terminal elements of the terminal for respective connection to the multiple conductors.

17. The method of claim 12, wherein providing the termination circuit comprises providing one or more components selected from the group consisting of: resistors, capacitors, and inductors.

18. The method of claim 12, wherein providing the termination circuit comprises providing a protection component.

19. The method of claim 12, wherein providing comprises providing a plurality of terminals including the terminal for connection to respective communication lines and providing a plurality of termination circuits including the termination circuit for connection to respective terminals of the plurality of terminals.

20. A method comprising:
connecting a communication line to a modular splice connector; and
securing a termination device to the modular splice connector, the termination device comprising a terminal for connection to the communication line through the modular splice connector, a termination circuit connected to the terminal and having an impedance matching a characteristic impedance of the communication line, and a housing carrying the terminal and the termination circuit.
